(19) United States
(12) Patent Application Publication
(10) Pub. No.: US 2007/0132261 A1
(43) Pub. Date: Jun. 14, 2007

(54) Collapsible Grab Handle

(76) Inventors: Craig Ehrlich, Lafayette, IN (US); Robert L. Hancock, Lafayette, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/560,573

(22) Filed: Nov. 16, 2006

Related U.S. Application Data
(60) Provisional application No. 60/749,073, filed on Dec. 9, 2005.

(51) Int. Cl. B60J 9/00

(52) U.S. Cl. 296/1.02

(57) ABSTRACT

A collapsible grip handle for mounting on a truck or trailer has a steel rod mounted between two brackets formed of spring steel. The brackets have an attachment section for fastening to a surface, a spring section which buckles under compressive load, and an attachment section to hold the rod. The entire assembly has a polymer overmold with ribs for slip-resistant gripping and a skirt to prevent the rod from pulling away under tension. The brackets buckle under a compressive load so that the handle bends and returns to the original position when the load is removed.

### PRIORITY

This application claims priority from U.S. Provisional Patent Application No. 60/749,073, filed Dec. 9, 2005, the disclosure of which is incorporated herein by reference.

### FIELD OF THE INVENTION

This invention is generally directed to a grab handle for use on a truck or trailer.

### BACKGROUND OF THE INVENTION

Many motor vehicles, including heavy-duty and light-duty trucks, tractors used in tractor-trailer tandems, and trailers themselves, require the use of grab handles in various places. Grab handles are commonly, if not necessarily, used at locations on a truck or trailer where personnel will be. For example, Regulation 399.207 of the Federal Motor Carrier Safety Administration of the United States Department of Transportation requires that a handhold be located within the reach of any cab-over-engine truck or truck tractor. Grab handles are also commonly used at the rear of a trailer of a tractor-trailer tandem and at the rear of a straight truck, for access to the cargo-holding area of the trailer or truck. Grab handles are also used at other locations that require a driver, assistant, or maintenance personnel to obtain access for safety inspections or for maintenance.

Prior art grab handles were typically forged or otherwise formed from a single piece of metal or molded in a single piece of hard plastic and welded, screwed to, or bolted to a surface of the truck or trailer. Some prior art handles have a rod connected to two brackets, which are then attached to a surface of the truck or trailer. In these designs, the prior art handles were rigid. Since a grab handle must carry the load of a driver or mechanic, grab handles are generally formed to have high tensile strength and must be able to withstand the load of a person pulling himself or herself onto the truck or trailer. The Section 399.207 regulation referred to above, for example, requires that a grab handle withstand a static load of at least 250 pounds uniformly distributed over the area of a hand print and applied away from the mounting surface.

But a higher compressive load applied to such a handle will either break the handle or, if in excess of the deformation strength of the underlying surface, will cause damage to the surface. For example, grab handles located at the rear of a trailer are subject to breaking as the trailer is backed up to a dock. A grab handle located on a cab can cause damage to the underlying sheet metal if involved in a side-swipe collision in a crowded truck yard or dock facility.

Other prior art handles are recessed into the structure of the trailer or truck. An underlying structure is built to support the handle; then the portion where the handle is to be recessed into the structure is cut out through machine or torch cutting. The cut-out area provides protection from impact for the handle and a hand hold for the user. These handles are time consuming and expensive to produce and result in poor aesthetics.

Therefore, a need exists for a grab handle having high tensile strength but able to buckle under a high compressive load. The present invention meets this need.

### SUMMARY OF THE INVENTION

Briefly, in a first embodiment, a collapsible grab handle has a rod and at least one bracket. The bracket has a base section, an attachment section holding the rod, and a spring section connecting the base section to the attachment section, the spring section being deformable under a compressive load from a first position wherein the rod is remote from the base section, to a second position wherein the rod is proximate to the base section. A polymer, preferably a thermoplastic polymer, may cover the entire assembly. The polymer overmold provides an attractive appearance, provides gripping friction by the use of ribs formed in the overmold, and prevents the rod from being pulled too far away from the bracket. The steel rod provides stiffness and strength. The spring section, preferably made of steel, allows the handle to compress under load, so that the rod moves from a first position away from the base, to a second position proximate to the base, and springs back when the compressive load is removed.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1A is a perspective view of a grab handle of an embodiment of the present invention in a first position;

FIG. 1B is a perspective view of the grab handle of FIG. 1A in a second position;

FIG. 2 is another perspective view of the grab handle of FIG. 1A in the first position;

FIG. 3 is a top plan view of the grab handle of FIG. 1A;

FIG. 4 is a front elevational view of the grab handle of FIG. 1A;

FIG. 5 is a side elevational view of a bracket of the grab handle of FIG. 1A with the overmold in place;

FIG. 6A is a side cross-sectional view of the bracket of FIG. 5, with the skirts of the overmold removed, in a first position;

FIG. 6B is a side cross-sectional view of the bracket of FIG. 5, with the skirts of the overmold removed, in a second position;

FIG. 7 is a cross-sectional perspective view of the bracket of the grab handle of FIG. 1A, showing a cross-sectional view at the line A-A of FIG. 5;

FIG. 8 is a top plan view of the steel components of the grab handle;

FIG. 9 is a front elevational view of the steel components of the grab handle of FIG. 1A;

FIG. 10 is a side plan view of the steel components of the grab handle of FIG. 1A;

FIG. 11 is a perspective view of the steel components of the grab handle of FIG. 1A;

FIG. 12 is a side view of the rod of the grab handle of FIG. 1A;

FIG. 13 is a perspective view of the rod of the grab handle of FIG. 1A;

FIG. 14 is a partial plan view of an embodiment of the bracket of FIG. 5;

FIG. 15 is a top perspective view of the bracket of FIG. 14;

FIG. 16 is a bottom perspective view of the bracket of FIG. 14;

FIG. 17 is a side detail view of the attachment section of the bracket of FIG. 14;

FIG. 18 is a rear perspective view of the bracket of FIG. 14;

FIG. 19 is a top plan view of the bracket of FIG. 14;

FIG. 20 is a front elevational view of the bracket of FIG. 14;

FIG. 21 is a bottom perspective view of a second embodiment of the bracket of the grab handle of FIG. 1A;

FIG. 22 is a top perspective view of the bracket of FIG. 21;

FIG. 23 is a top plan view of the steel components of the bracket of FIG. 21;

FIG. 24 is a front elevational view of the steel components of the bracket of FIG. 21;

FIG. 25 is a side elevational view of the steel components of the bracket of FIG. 21;

FIG. 26 is a perspective view of the steel components of the bracket of FIG. 21;

FIG. 27 is a plan view of the grab handle of FIG. 1A, as attached to a corner post of a trailer, showing the door closed;

FIG. 28 is a plan view of the grab handle of FIG. 27, as attached to a corner post of a trailer, showing the door partially open;

FIG. 29 is a plan view of the grab handle of FIG. 27, as attached to a corner post of a trailer, showing the door open;

FIG. 30 is a plan view of the grab handle of FIG. 27, as attached to a corner post of a trailer, showing the door completely open;

FIG. 31 is an elevational view of the grab handle of FIG. 1A, as attached to a corner post of a trailer, showing the door closed; and

FIG. 32 is an elevational view of the grab handle of FIG. 1A, as attached to a corner post of a trailer, showing the door open.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

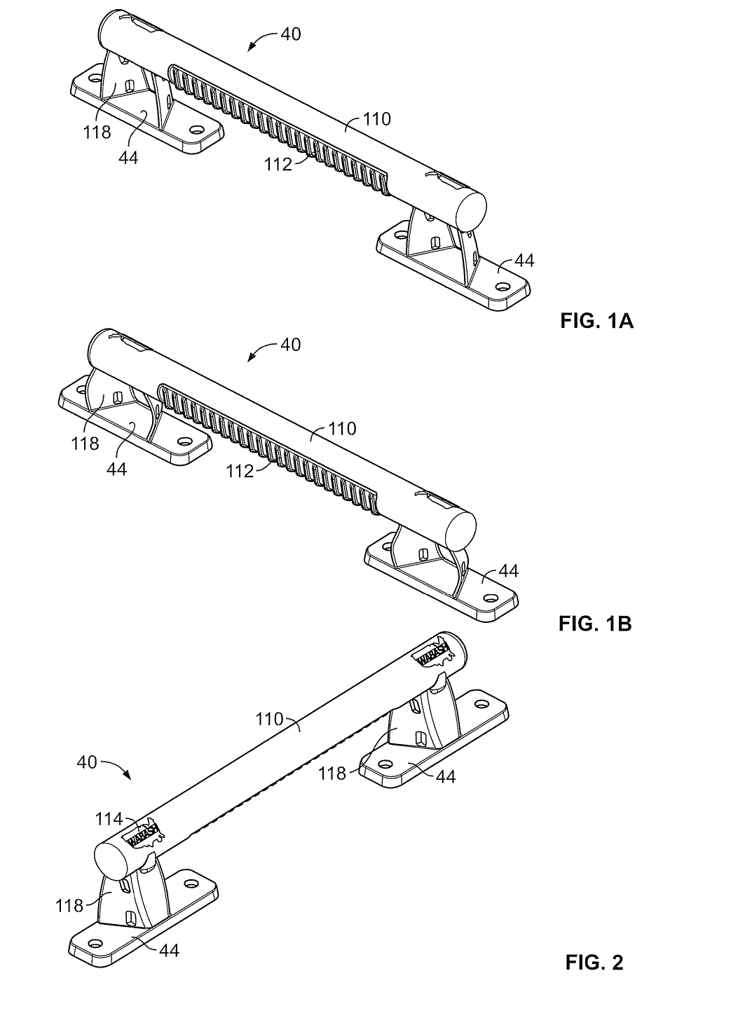

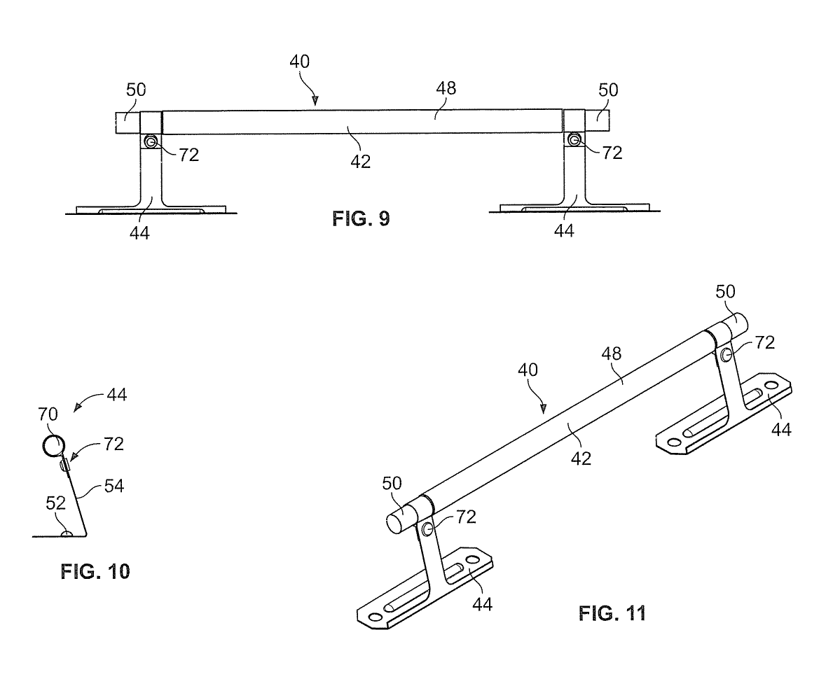

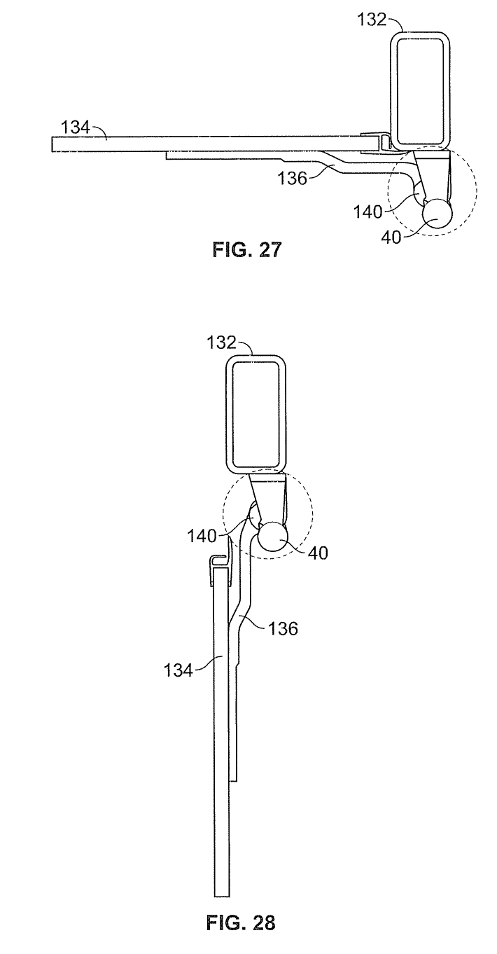

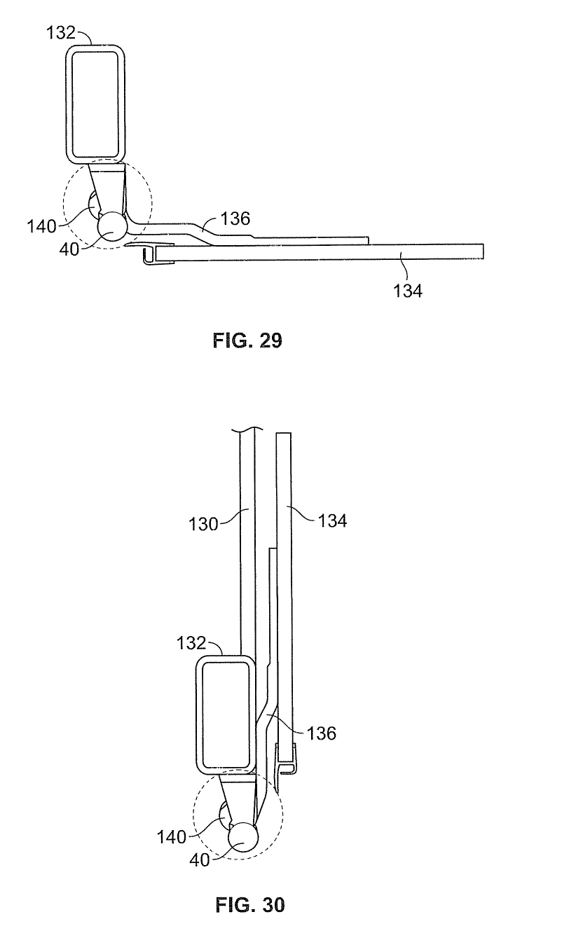

A first embodiment of the present invention is described with relation to FIGS. 1 through 20. The grab handle 40 is an assembly of a rod 42 and one or more brackets 44, with a polymer overmold 46. As illustrated, two brackets 44 are provided. One, three, or some other number of brackets 44 can be provided in a user's particular application. The grab handle 40 is mounted on a trailer 130 for hauling cargo, as shown in FIGS. 27 through 32.

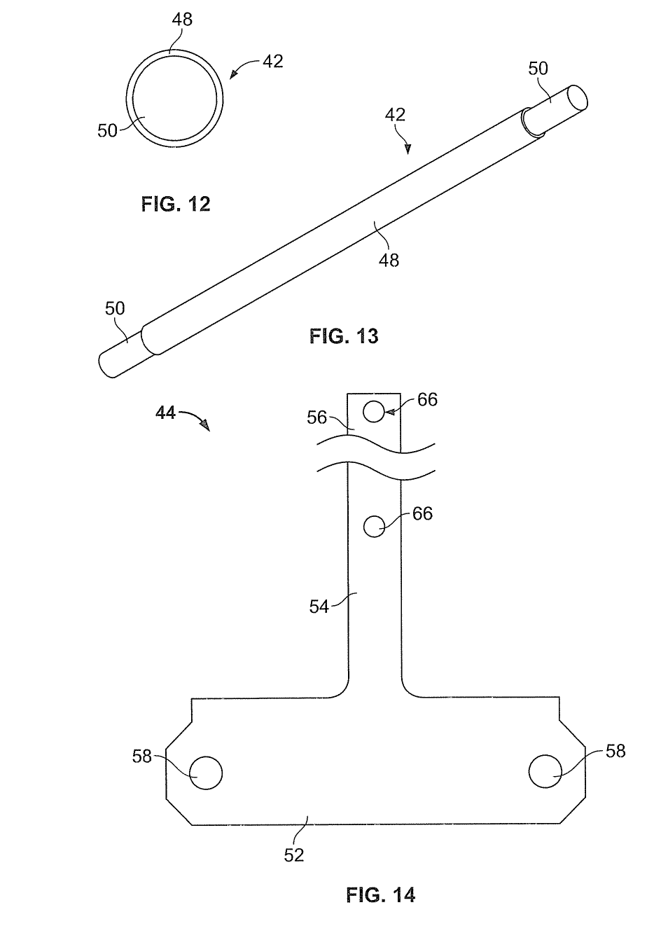

Rod 42, as shown in detail in FIGS. 12 and 13, is a cylindrical tube made of a material of high tensile strength, preferably steel, most preferably 1045 steel. The rod 42 has a total length of 11.5 inches, but can be of any length sufficient for a person to grasp. A grasping section 48, which is between the brackets 44, has a diameter of 0.56 inches. A head 50 at each end of grasping section 48 has a smaller diameter, preferably of 0.50 inches and is preferably 1.09 inches long. Alternatively, grasping section can extend through and past brackets 44.

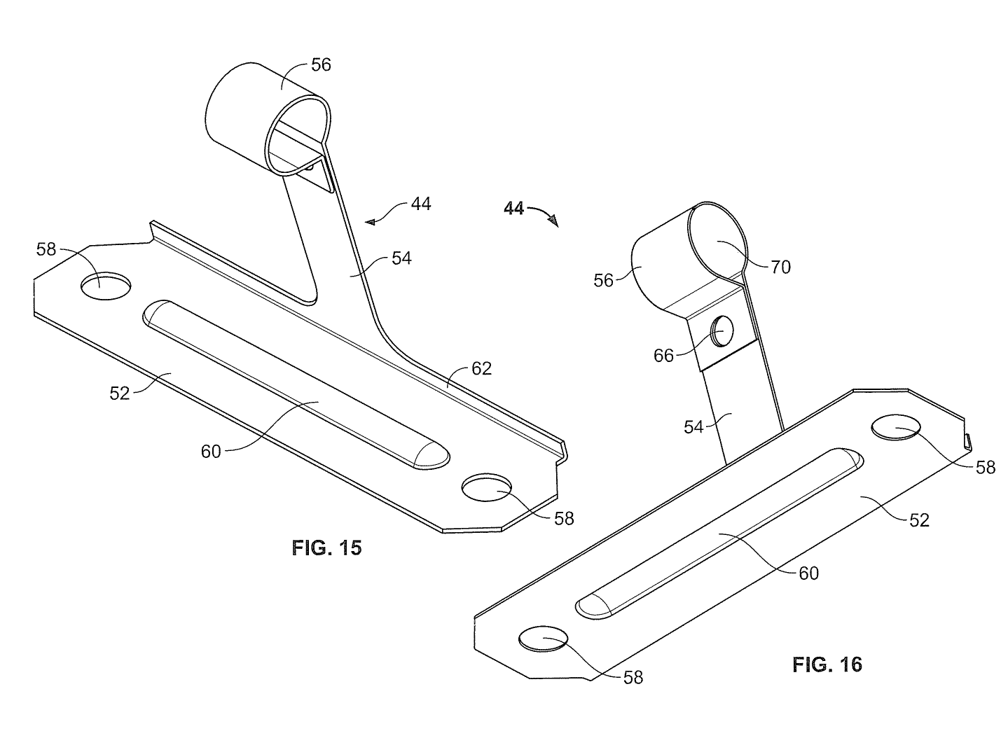

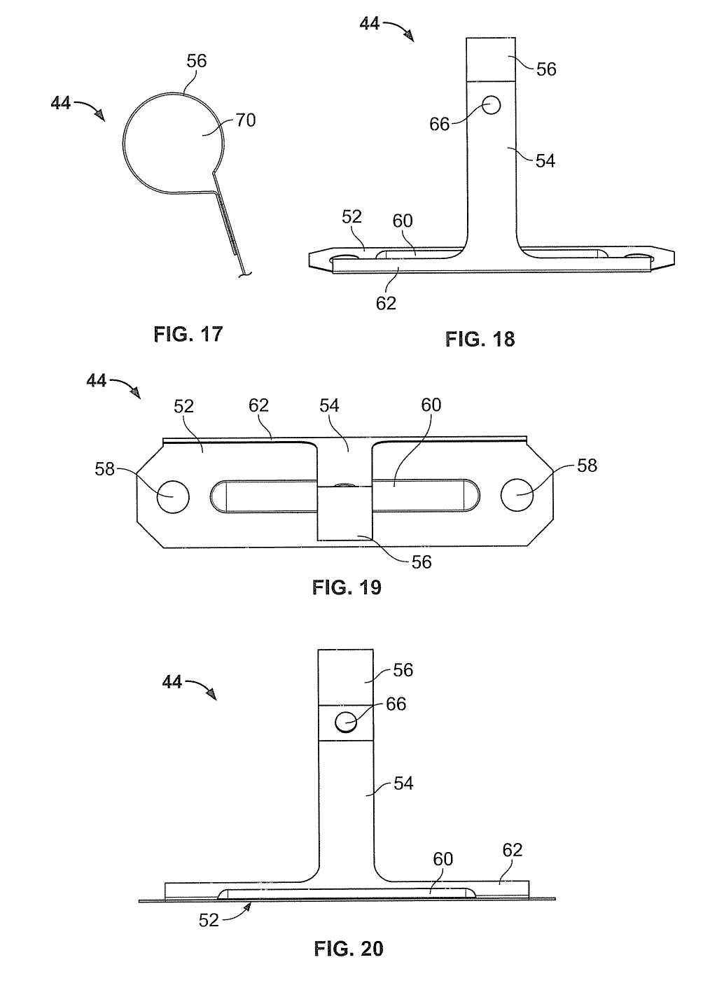

A first embodiment of bracket 44 is shown in plan view, as stamped but before forming, in FIG. 14, in perspective views after forming in FIGS. 15 and 16, and in elevational views and plan after forming in FIGS. 17 through 20. Bracket 44 is preferably a unitary structure, stamped of a single piece of metal, preferably spring steel, and most preferably 17-7 precipitation stainless steel, because of the high strength-to-weight ratio of that material. Bracket 44 has a base section 52, a spring section 54, and attachment section 56. Base section 52 is a sheet, preferably an extended octagon, with the extended axis being parallel to the axis of rod 42. Base section 52 contains two apertures 58 proximate to the ends thereof. Base section 52 will be juxtaposed to the mounting surface of the truck or trailer and will attach to that surface by sheet-metal screws, bolts, snaps, rivets, pins, or other suitable fastener, through apertures 58. Base section 52 as illustrated has a flat shape, to fit against a flat mounting surface, but can be shaped to conform to a curved mounting surface, as the final application may require. In the preferred embodiment, base section 52 is four inches long by one inch wide. Base section 52 in one embodiment has a pressed ridge 60 to add stiffness, as shown in FIGS. 15, 16, 18, and 20.

Spring section 54 is a generally rectangular member projecting from the middle of a stiffening bead 62 formed at one elongated edge 64 of base section 52. Stiffening bead 62 and spring section 54 form an acute angle to base section 52, preferably about a 75-degree angle. In the preferred embodiment, stiffening bead 62 is 0.10 inches high. Spring section 54 is in a first position, as shown in, for example, FIG. 6A, when no load is applied to grab handle 40. In this first position, attachment section 56, and therefore, rod 42, are remote from base section 52. When a compressive load is applied to grab handle 40, such as by a driver backing the trailer 130 against a wall of a dock facility or another truck or trailer being driven into trailer 130, spring section 54 bends from its first position to a second position as shown in, for example, FIG. 6B. In this second position, attachment section 56, and therefore, rod 42, are proximate to base section 52.

Attachment section 56, at the end 68 of spring section 52 opposite stiffening bead 62, is turned in a circle to form bore 70. Attachment section 56 has one or more apertures 66 formed therein. After head 50 of rod 42 has been placed in bore 70, a rivet 72 through aperture 66 secures attachment section 56 around rod 42, as shown in FIGS. 8 through 11. Alternatively, rod 42 can be welded to bracket 44, attached to bracket 44 by sheet-metal screws, threaded into threads formed in bracket 44, secured to bracket 44 by an interference fit, or otherwise fastened to bracket 44.

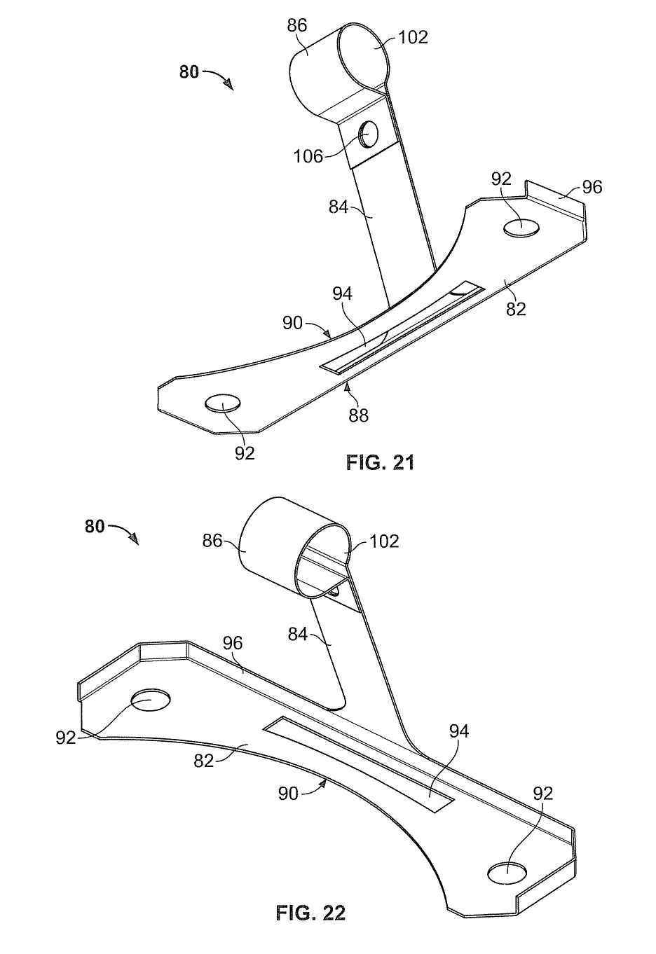

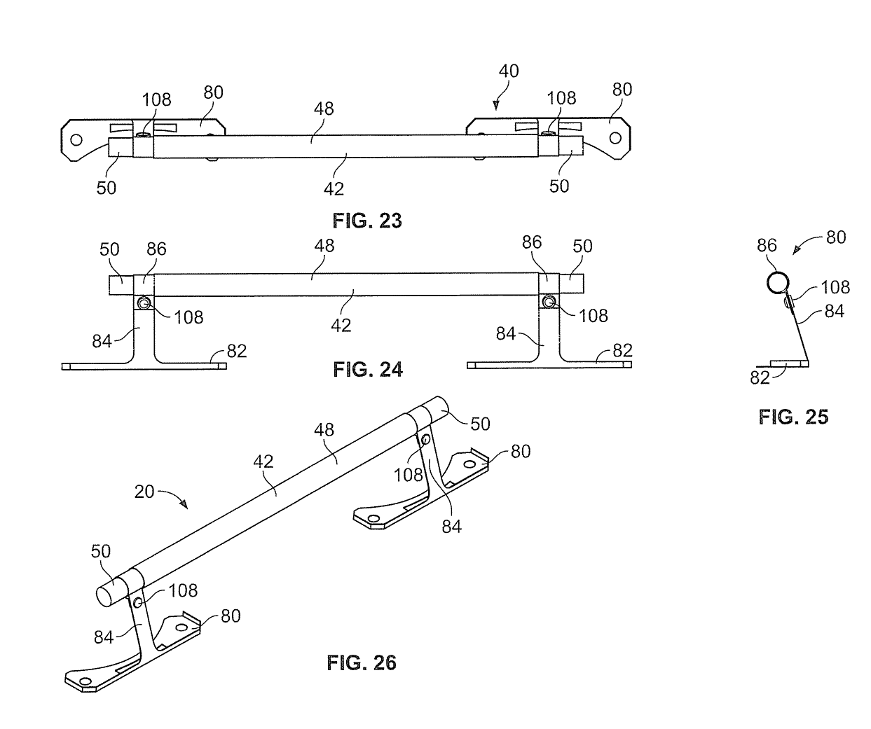

A second embodiment of grab handle 20 has bracket 80, as shown in perspective views in FIGS. 21 and 22. In this embodiment, brackets 80 are attached to a rod 42 as described above and as illustrated in FIGS. 23 through 26. Bracket 80 is also stamped and formed of a unitary piece of metal, preferably spring steel, and most preferably 17-7 precipitation stainless steel, because of the high strength-to-weight ratio of this material. Bracket 80 has a base section 82, a spring section 84, and attachment section 86.

Base section 82 is a sheet formed with a wing-like shape, having a straight first side 88 and an inwardly-bowed, arcuate shape on a second side 90, with an extended axis parallel to the axis of rod 42. Base section 82 contains one or more apertures 92 at opposite ends thereof. Base section 82 will be juxtaposed to the mounting surface of the truck or trailer and will attach to that surface by sheet-metal screws, bolts, snaps, rivets, pins, or other suitable fasteners through apertures 92. Base section 82 as illustrated has a flat shape, to fit against a flat mounting surface, but can be shaped to conform to a curved mounting surface, as the final application may require. Base section 82 also has a central void 94, to save weight. In the preferred embodiment, base section 82 is four inches long by one inch wide.

Spring section 84 is a generally rectangular member projecting from the middle of a stiffening bead 96 formed at first side 88 of base section 82. Stiffening bead 96 and spring section 84 form an angle to base section 82, preferably about a 75-degree angle. In the preferred embodiment, stiffening bead 96 is 0.10 inches high. Spring section 84 also bends from a first position to a second position, in the same manner as described in connection with spring section 54 and as illustrated in, for example, FIGS. 6A and 6B.

Attachment section 86, at the end 100 of spring section 84 opposite stiffening bead 96, is turned in a circle to form bore 102. Attachment section 86 is a generally rectangular member having two apertures 106 formed therein. After head 50 of rod 42 has been placed in bore 102, a rivet 108 through apertures 106 secures attachment section 86 around rod 42, as shown in FIGS. 23 through 26. Alternatively, rod 42 can be welded to bracket 80, attached to bracket 80 by sheet-metal screws, threaded into threads formed in bracket 80, secured to bracket 80 by an interference fit, or otherwise fastened to bracket 80.

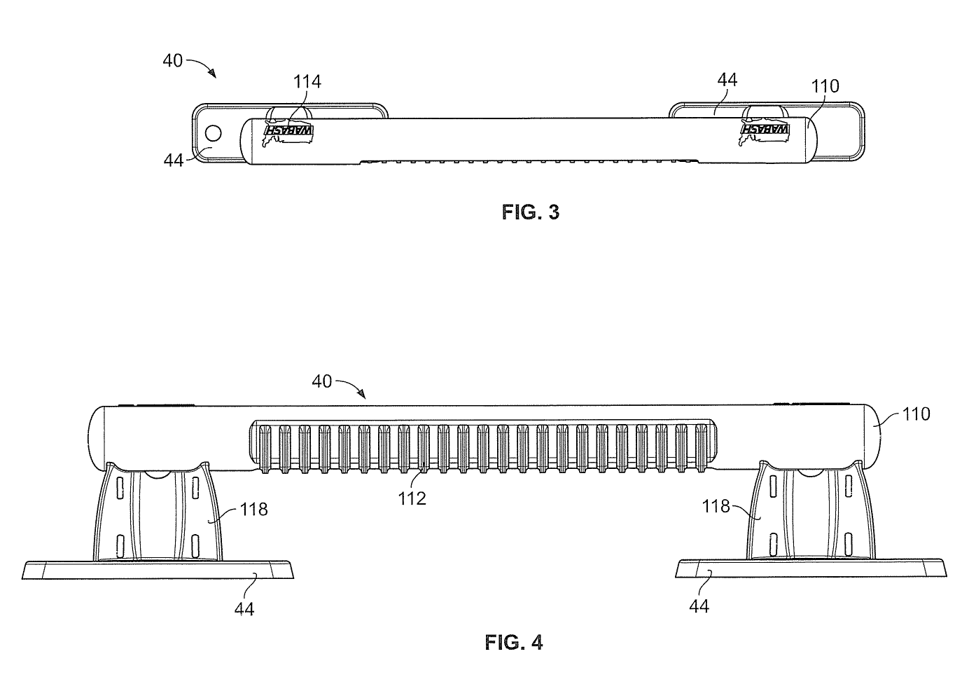

Preferably, after two brackets 44 have been attached to either end of rod 42, as shown in FIGS. 8 through 11 and 23 through 26, a polymer overmold 110 is applied to the entire assembly. Overmold 110 is made of a moldable thermoplastic, preferably linear low-density polyethylene. Overmold 110 provides an attractive appearance and can be dyed to match to or complement the color of the underlying surface to which handle 40 will attach, or can be colored to contrast with the color of the underlying surface, such as by using a fluorescent dye for safety. Ribs 112 can be formed in the overmolding process to provide slip-resistance, as shown in FIGS. 1 and 4. Ribs 112 are preferably spaced closely, but can be as large as finger-sized depressions. Other information can be molded into overmold 110, such as a manufacturer's name 114 or logo 116, as shown in FIGS. 2 and 3.

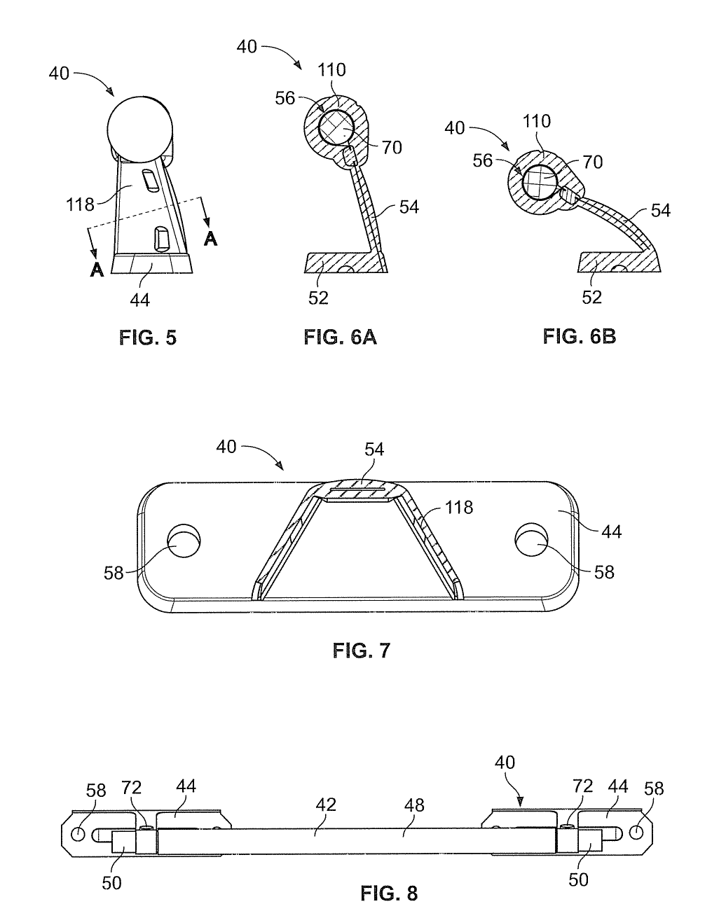

Overmold 110 may have skirts 118 on each side of spring section 52 or 84. Skirts 118 extend from rod 42 to base section 50 or 82, as shown in FIGS. 1 through 5, and in cross-sectional view, along section A-A of FIG. 5, in FIG. 7.

When no load is applied to grab handle 40, it is in its first, relaxed position in which rod 42 is remote from base section 52, as shown in, for example, FIGS. 1A and 6A. When a tension load is applied to grab handle 40, such as by a user grasping rod 42 and pulling, skirts 118 prevent spring section 54 from bending further away from base section 52. When a compressive load is applied to grab handle 40, such as by a driver backing trailer 130 against a wall of a dock facility or another truck or trailer being driven into trailer 130, skirts 116, being part of the overmold 110 and therefore made of the same plastic, flex as rod 42 moves from its first, relaxed position to a second, compressed position proximate or closer to base section 52, as shown in FIG. 1B. When the compressive load is removed, spring section 54 returns rod 42 to its first, relaxed position.

Accordingly, handle 40 provides a safe handhold when a tensile load is applied, but will collapse under a compressive load. For example, if a trailer 130 is backed up to a dock but is not aligned properly, a grab handle of the prior art on the rear of trailer 130 could encounter the walls of the dock facility or the door assembly for the dock, and would break and possibly damage the corner post of trailer 130. Grab handle 40, however, will compress when encountering the wall and remain compressed until trailer 130 is pulled away from the dock, at which time grab handle 40 returns to its original position, minimizing the likelihood of damage to grab handle 40 or to trailer 130.

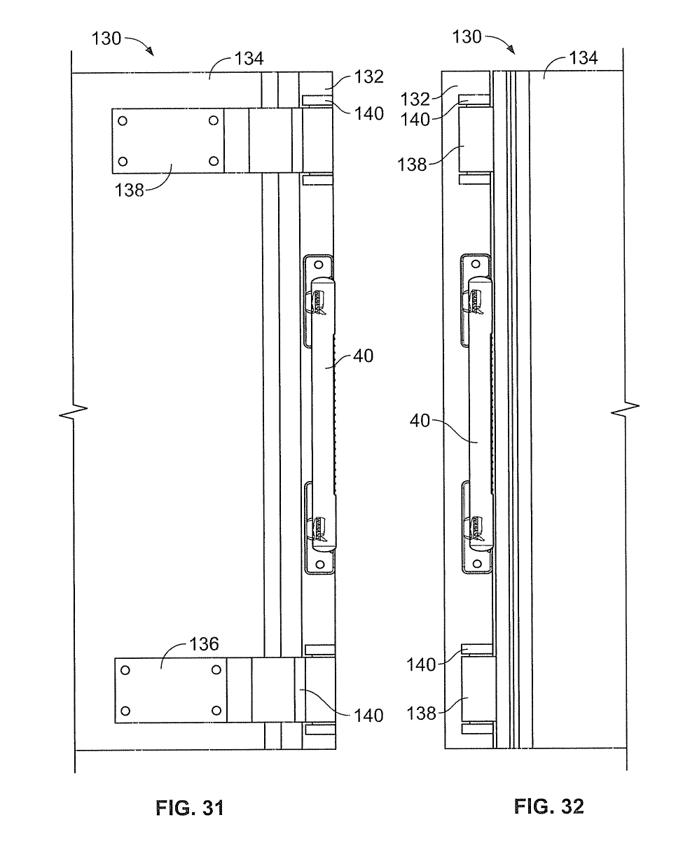

Grab handle 40 can be attached to any part of a truck or trailer 130. In the preferred embodiment, grab handle 40 is attached to the rear of a truck or trailer 130, on the corner post 132 that supports a door 134, mounted vertically between the two hinges 136, 138 that hold door 134 to corner post 132, as shown in plan view in FIGS. 27 through 30 and in elevational view in FIGS. 31 and 32. In this embodiment, the pin 140 of each hinge 136, 138 is oriented a sufficient distance away from corner post 132, that door 134 will swing away from corner post 132, through a 180-degree arc, around to the side of trailer 130, to the position used for backing to a dock, and will clear grab handle 40. Accordingly, grab handle 40 will be available for use by a driver or loader whether door 134 is open or closed. Grab handle 40 can be used elsewhere on a trailer or truck for the same advantage.

While preferred embodiments of the present invention are shown and described, it is envisioned that those skilled in the art may devise various modifications of the present invention without departing from the spirit and scope of the appended claims.

The invention that is claimed is:

1. A collapsible grab handle, comprising:
a rod; and
at least one bracket comprising a base section, an attachment section holding said rod, and a spring section connecting said base section to said attachment section, said spring section being deformable under a compressive load from a first position wherein said rod is remote from said base section, to a second position wherein said rod is proximate to said base section.

2. The grab handle of claim 1, further comprising an overmold.

3. The grab handle of claim 2, wherein said overmold comprises a moldable thermoplastic.

4. The grab handle of claim 2, further comprising ribs formed in said overmold over said rod.

5. The grab handle of claim 2, further comprising a skirt formed in said overmold on said spring section and extending from said rod to said base section, said skirt flexing as said rod moves from said first position to said second position.

6. The grab handle of claim 1, wherein said spring section is made of steel.

7. The grab handle of claim 6, wherein said steel is spring steel.

8. The grab handle of claim 7, wherein said steel is 17-7 precipitation stainless steel.

9. The grab handle of claim 1, wherein said bracket comprises a unitary structure.

10. The grab handle of claim 9, wherein said bracket is made of steel.

11. The grab handle of claim 10, wherein said steel is spring steel.

12. The grab handle of claim 11, wherein said steel is 17-7 precipitation stainless steel.

13. The grab handle of claim 1, wherein said spring section and said base section form an acute angle.

14. The grab handle of claim 13, wherein said acute angle is about 75 degrees.

15. The grab handle of claim 1, further comprising a void in said base section.

16. The grab handle of claim 1, further comprising at least one of a stiffening bead formed on a side of said base section and a ridge formed on said base section.

17. The grab handle of claim 1, wherein said rod is steel.

18. The grab handle of claim 17, wherein said steel is 1045 steel.

19. The grab handle of claim 1, wherein said grab handle is mounted to a trailer.

20. The grab handle of claim 19, wherein said grab handle is mounted to a corner post of said trailer.
